(19) United States
(12) Patent Application Publication
(10) Pub. No.: US 2026/0164139 A1
(43) Pub. Date: Jun. 11, 2026

(54) IMAGE CAPTURE APPARATUS AND CONTROL METHOD

(71) Applicant: CANON KABUSHIKI KAISHA, Tokyo (JP)

(72) Inventors: WAKAKI HATTORI, Tokyo (JP); TORU KOBAYASHI, Tokyo (JP)

(21) Appl. No.: 19/402,206

(22) Filed: Nov. 26, 2025

(30) Foreign Application Priority Data
Dec. 9, 2024 (JP) 2024-214572

(51) Int. Cl. H04N 23/84; H04N 23/72; H04N 23/74; H04N 23/75

(52) U.S. Cl. CPC H04N 23/84; H04N 23/72; H04N 23/74; H04N 23/75

(57) ABSTRACT

An image capture apparatus captures an object image through an optical system, and records an image captured by the imaging unit and records third correction data to be used to apply first correction processing including at least one of peripheral illumination correction and lateral chromatic aberration correction to an image to which second correction processing including at least one of distortion correction and image magnification correction is applied.

### BACKGROUND

### Field of the Technology

The present disclosure relates to a technical field of compositing a live-action image and CG.

### Description of the Related Art

In virtual production or Visual Effects (VFX), when compositing an image shot by an image capture apparatus such as a digital camera and computer graphics (CG), an operation of removing the optical aberration (peripheral illumination, distortion aberration, and the like) of an image capture optical system is performed for the shot image. In recent years, since a flexibility of image processing after shooting is high, a RAW moving image has been used as an image to be composited with CG in virtual production or VFX.

Japanese Patent Laid-Open No. 2014-23063 describes an image capture apparatus that records, in association with a RAW moving image, lens aberration correction data for correcting the aberration of a lens attached to a camera when shooting the RAW moving image. In Japanese Patent Laid-Open No. 2014-23063, when compositing a RAW moving image and CG, lens aberration correction data is obtained from metadata added to the RAW moving image before composition and the lens aberration is removed, thereby performing composition.

While a digital camera can be set to correct the lens aberration in development processing of a RAW moving image, the digital camera records, in a RAW moving image file, as metadata, correction data for lens aberration correction set in the digital camera without applying lens aberration correction. This can apply optical aberration correction set in the digital camera in the development processing of the RAW moving image.

In the development processing of the RAW moving image, after applying correction (first correction processing) of a pixel value such as peripheral illumination correction or lateral chromatic aberration correction, geometric transformation (second correction processing) such as distortion aberration correction is applied. In this case, correction data used for the first correction processing is effective only for an image obtained before the second correction processing is applied, and cannot be applied to an image obtained after the second correction processing has been applied. The first correction processing and the second correction processing need to be applied to a moving image to be composited with CG. Therefore, as in Japanese Patent Laid-Open No. 2009-43060, there is proposed a method of applying inverse transformation of distortion aberration correction to an image obtained after distortion aberration correction has been applied and then applying lateral chromatic aberration correction to the image.

However, in Japanese Patent Laid-Open No. 2009-43060, image quality may degrade by applying inverse transformation of distortion aberration correction.

### SUMMARY

The present disclosure has been made in consideration of the aforementioned problems, and provides technical advantages in applying necessary optical aberration correction while suppressing degradation of image quality at the time of image composition.

In order to solve the aforementioned problems, the present disclosure is directed to an image capture apparatus comprising: an imaging unit that captures an object image through an optical system; and a recording unit that records an image captured by the imaging unit and records third correction data to be used to apply first correction processing including at least one of peripheral illumination correction and lateral chromatic aberration correction to an image to which second correction processing including at least one of distortion correction and image magnification correction is applied.

According to the present disclosure, it is possible to apply necessary optical aberration correction while suppressing degradation of image quality at the time of image composition.

Features of the present disclosure will become apparent from the following description of embodiments with reference to the attached drawings. The following description of embodiments is given by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are block diagrams each exemplifying the configuration of a system and apparatuses according to the present embodiment;

FIG. 2 is a view illustrating functions of a development application and an image composition application according to the present embodiment;

FIGS. 3A and 3B are flowcharts exemplifying moving image shooting processing according to the present embodiment;

FIG. 4 is a flowchart exemplifying development processing according to the present embodiment; and

FIGS. 5A and 5B are flowcharts exemplifying image composition processing according to the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

The present embodiment will describe an example in which in a system where an image capture apparatus and an information processing apparatus are communicatively connected, processing of shooting a moving image by the image capture apparatus and compositing, in real time, by the information processing apparatus, the moving image shot by the image capture apparatus with an image (to be referred to as CG hereinafter) created in advance such as computer graphics (CG) is performed.

### Apparatus Configuration

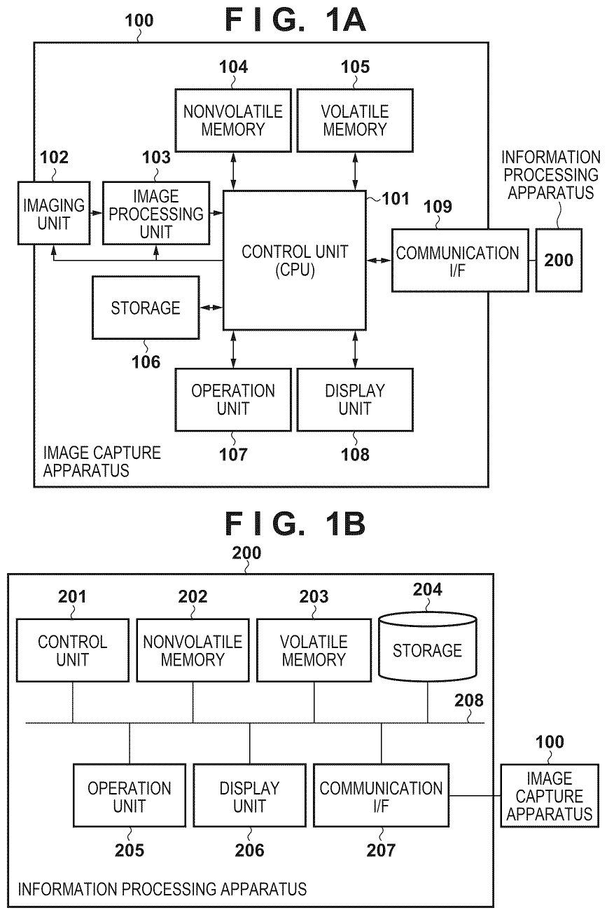

First, the configuration and function of an image capture apparatus according to the present embodiment will be described with reference to FIG. 1A.

An image capture apparatus 100 according to the present embodiment is, for example, a digital camera, a digital video camera, a smartphone or a tablet computer having a camera function and a communication function, or a Web camera.

The function of the image capture apparatus 100 according to the present embodiment is implemented by a software program executed by hardware and/or a control unit 101 shown in FIG. 1A.

The image capture apparatus 100 according to the present embodiment includes the control unit 101, an imaging unit 102, an image processing unit 103, a nonvolatile memory 104, a volatile memory 105, a storage 106, an operation unit 107, a display unit 108, and a communication I/F 109.

The control unit 101 is an arithmetic processor such as a CPU or an MPU that generally controls the entire image capture apparatus 100, and executes programs stored in the nonvolatile memory 104 to be described later, thereby implementing control processing to be described later. Note that instead of controlling the entire apparatus by the control unit 101, a plurality of hardware components may control the entire apparatus by sharing processing.

The imaging unit 102 includes an image capture optical system. The image capture optical system includes a lens group including a zoom lens and a focus lens, and a shutter having an aperture function. Furthermore, the imaging unit 102 includes an image sensor formed by a CCD or CMOS element that converts an object image into an electrical signal, and an A/D converter that converts an analog image signal output from the image sensor into a digital signal. Under the control of the control unit 101, the imaging unit 102 converts object image light whose image is formed by the lenses included in the imaging unit 102 into an electrical signal by the image sensor, performs noise reduction processing or the like, and outputs a digital image signal. Note that the image capture optical system including the lens group and the shutter may be detachable from the image capture apparatus 100.

The image processing unit 103 includes a Graphics Processing Unit (GPU), and executes various kinds of image processes including development processing for a RAW image signal of a still image or a moving image generated by the imaging unit 102. The image processing unit 103 creates an image file by compression-coding still image data having undergone the image processing by JPEG or the like, or by encoding moving image data by a moving image compression method such as MP4 or MXF, and records the image file in the storage 106 such as a memory card. The image processing unit 103 records, in the storage 106, a RAW moving image file obtained without performing the image processing for the RAW image signal of the still image or the moving image generated by the imaging unit 102. Furthermore, the image processing unit 103 performs predetermined arithmetic processing using an image signal generated by the imaging unit 102, and the control unit 101 controls the focus lens, the aperture, and the shutter of the imaging unit 102 based on the obtained arithmetic result, thereby performing Auto Focus (AF) processing or Auto Exposure (AE) processing.

The image processing applicable by the image processing unit 103 includes pixel interpolation processing, color interpolation (demosaic) processing, white balance processing, and a plurality of kinds of correction processes associated with the optical aberration of the image capture optical system. The correction processes associated with the optical aberration include correction (first correction processing) of a pixel value such as peripheral illumination correction and/or lateral chromatic aberration correction and geometric transformation (second correction processing) such as distortion aberration correction and/or image magnification correction.

The correction data used for optical aberration correction includes first correction processing data used for the first correction processing, second correction data used for the second correction processing, and third correction data used to apply the first correction processing to an image to which the second correction processing has been applied.

The image capture apparatus 100 according to the present embodiment can individually set optical aberration correction processing to be applied to a shot moving image to be enabled (ON) or disabled (OFF) among the plurality of optical aberration correction processes when the user presets it via a menu screen. For example, it is possible to make a setting of applying not the first correction processing but the second correction processing (peripheral illumination correction OFF/distortion aberration correction ON) at the time of shooting a moving image. When shooting a moving image in an encoding format such as MP4 or MXF other than the RAW format, out of the first correction processing and the second correction processing, the correction processing that is set to ON is applied.

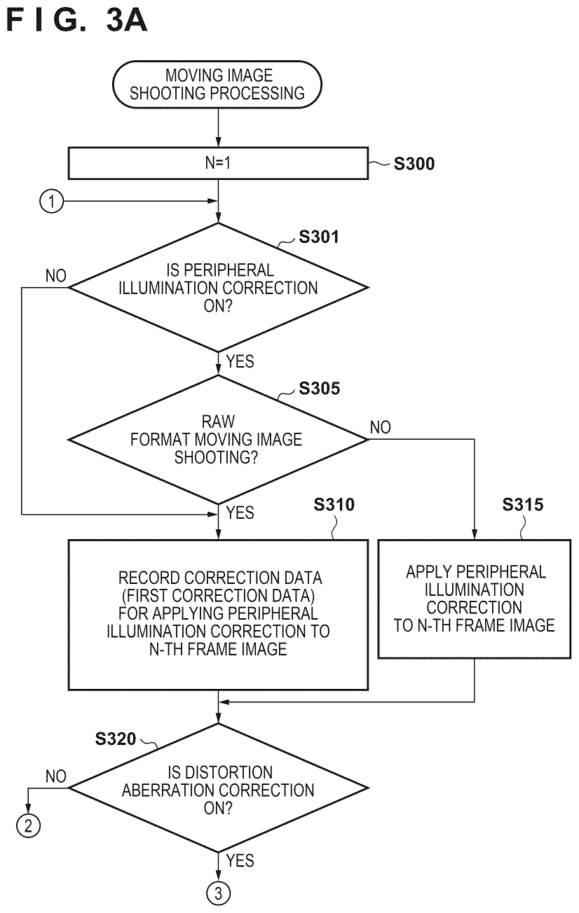

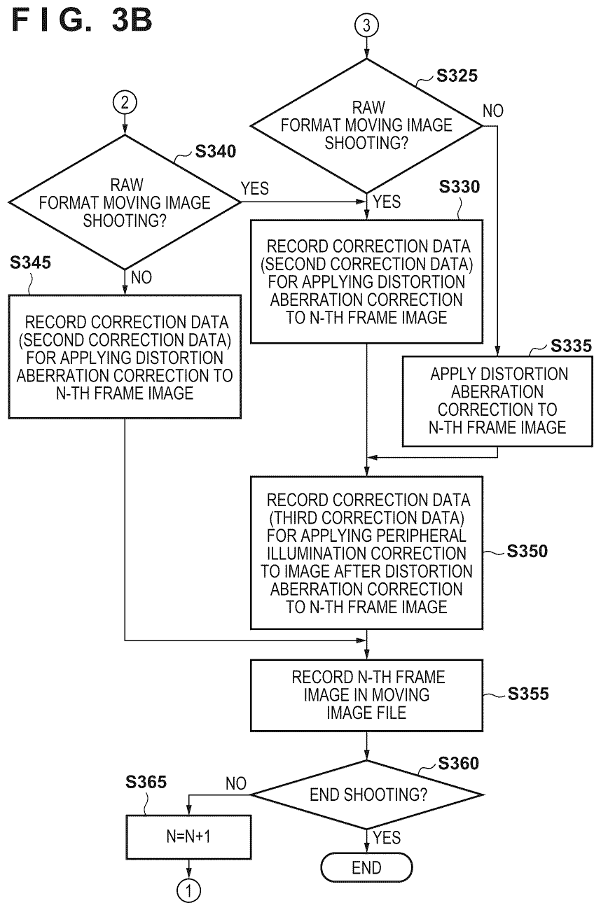

The nonvolatile memory 104 is a flash memory, a solid-state drive (SSD), a hard disk drive (HDD), or the like from which data can be removed and in which data can be written. The nonvolatile memory 104 records constants for the operation of the control unit 101, programs, and the like. The programs are those for executing control processing to be described later with reference to FIGS. 3A and 3B.

The volatile memory 105 is a RAM that temporarily stores a program read out from the nonvolatile memory 104, constants and variables for executing the program, and the like. In addition, the volatile memory 105 is used as a work memory of the control unit 101 and the image processing unit 103. The volatile memory 105 is used as a buffer memory that temporarily holds the image signal generated by the imaging unit 102, the image data processed by the image processing unit 103, and the like, or an image display memory of the display unit 108.

The storage 106 is a storage device such as a hard disk drive or a solid-state drive incorporated in the image capture apparatus 100 or connectable to the image capture apparatus 100. The storage 106 can also be implemented as an external storage device formed from a medium (recording medium) and a media drive that can access the medium. The external storage device may be a server apparatus connected via a network. The storage 106 stores a program for implementing the control processing to be described later with reference to FIGS. 3A and 3B, the image data such as a still image or a moving image shot by the image capture apparatus 100, and the like.

The operation unit 107 includes input devices such as various kinds of switches, buttons, and dials for accepting various kinds of operations from the user, and outputs operation information to the control unit 101. The operation unit 107 includes, for example, a power button that turns on or off a power supply, a shooting button that instructs to start or end shooting of a still image or shooting of a moving image, a reproduction button that instructs reproduction of an image, and a mode switching button that changes the operation mode of the image capture apparatus 100. The input device may be a software button or key using a touch display.

In a mode of shooting a still image, Auto Focus (AF) processing or Auto Exposure (AE) processing is executed based on the image signal generated by the imaging unit 102. Furthermore, the control unit 101 executes shooting processing of recording, in the storage 106, as a still image file, still image data obtained by performing the image processing for the image signal generated by the imaging unit 102.

In a mode of shooting a moving image, the control unit 101 executes Auto Focus (AF) processing or Auto Exposure (AE) processing based on an image signal generated for each frame by the imaging unit 102. Furthermore, the control unit 101 executes shooting processing of recording, in the storage 106, as a moving image file, moving image data in a format other than the RAW format obtained by performing the image processing for the image signal generated by the imaging unit 102 and recording, in the storage 106, as a RAW moving image file, moving image data in the RAW format having undergone no image processing. The control unit 101 starts shooting processing of a moving image when the shooting button is pressed for the first time, and continues the shooting processing of the moving image until the shooting button is pressed again. Furthermore, the control unit 101 stops the shooting processing of the moving image when the shooting button is pressed again, and records, in the storage 106, the moving image data for the time from the start to the stop of the shooting processing.

The display unit 108 performs display of a live view image generated by the imaging unit 102, display of a shot image, display of an image to be reproduced, and display of a Graphical User Interface (GUI) that accepts a user operation. The display unit 108 is, for example, a display device such as a liquid crystal display or an organic EL display. The display unit 108 may be integrated with the image capture apparatus 100, or may be an external apparatus connected to the image capture apparatus 100. The image capture apparatus 100 need only be able to be connected to the display unit 108 and control display on the display unit 108.

The communication interface (I/F) 109 executes communication with an information processing apparatus 200 via a network such as the Internet or a Local Area Network (LAN) by a wired method or a wireless method. The image capture apparatus 100 according to the present embodiment transmits, to the information processing apparatus 200 via the communication I/F 109, the moving image file in the format other than the RAW format or the moving image file in the RAW format stored in the storage 106.

The configuration and the functions of the information processing apparatus according to the present embodiment will be described next with reference to FIG. 1B.

The information processing apparatus 200 according to the present embodiment is a general-purpose computer such as a personal computer (PC) or a tablet computer, or a dedicated computer such as a server computer. The processing of the information processing apparatus 200 according to the present embodiment may be implemented by a single computer apparatus or by distributing respective functions to a plurality of computer apparatuses, as needed. The plurality of computer apparatuses are communicatively connected to each other.

The function of the information processing apparatus 200 according to the present embodiment is implemented by a software program executed by hardware and/or a control unit 201 shown in FIG. 1B.

The information processing apparatus 200 according to the present embodiment includes the control unit 201, a nonvolatile memory 202, a volatile memory 203, a storage 204, an operation unit 205, a display unit 206, a communication I/F 207, and a system bus 208.

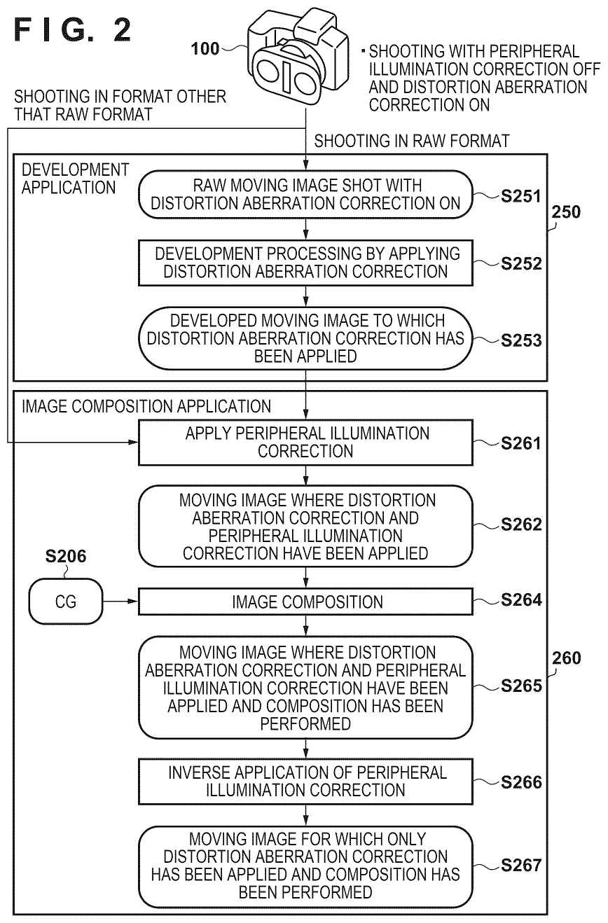

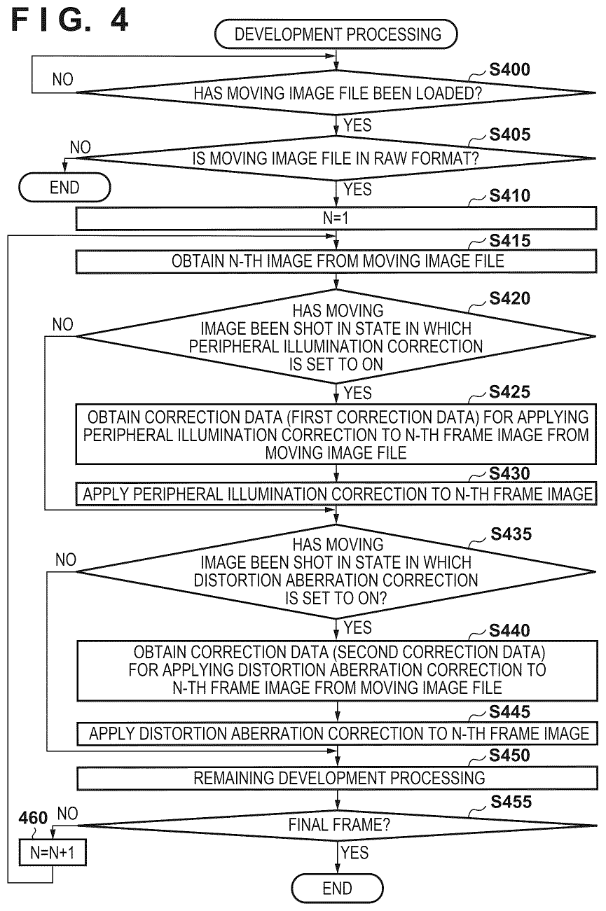

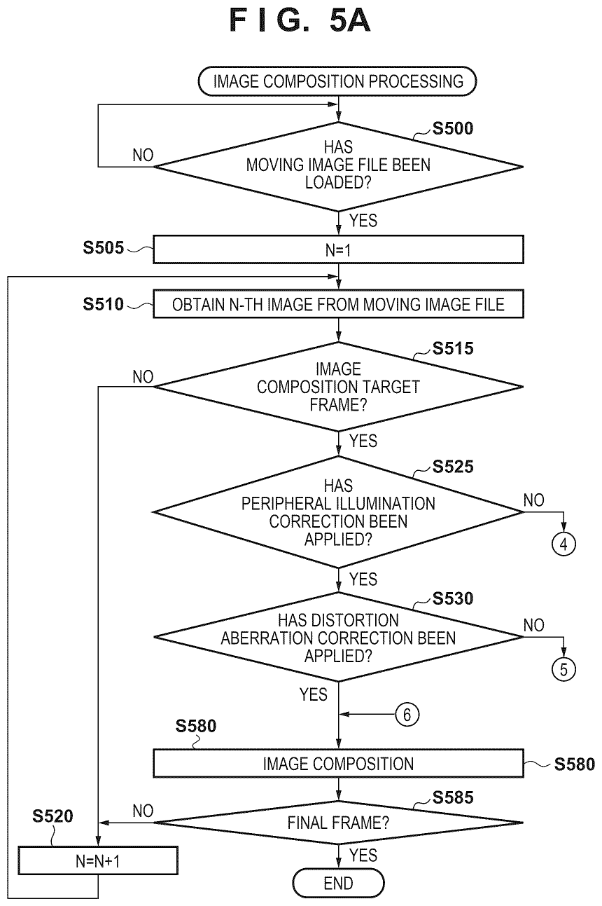

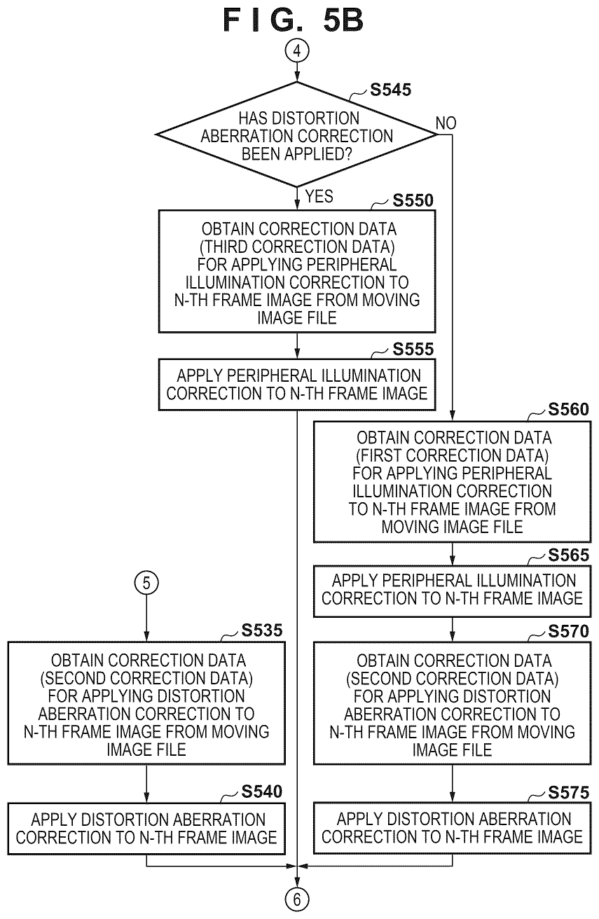

The control unit 201 includes an arithmetic processor such as a CPU or an MPU that generally controls the entire information processing apparatus 200. The nonvolatile memory 202 is a program memory such as a ROM that stores programs to be executed by the processor of the control unit 201 and parameters. The programs are those for implementing the functions of applications to be described later with reference to FIG. 2 and control processes to be described later with reference to FIGS. 4 and 5.

The volatile memory 203 is a data memory such as a RAM that temporarily stores a program read out from the nonvolatile memory 202, constants and variables for executing the program, and the like. The volatile memory 203 includes a work area of the program of the control unit 201, a save area in error processing, and a program load area.

Note that the program memory may be implemented by loading a program from an external storage device connected to the information processing apparatus 200 of the present embodiment into the volatile memory 203.

The storage 204 is a storage device such as a hard disk drive or a solid-state drive incorporated in the information processing apparatus 200 or connectable to the information processing apparatus 200. The storage 204 can also be implemented as an external storage device formed from a medium (recording medium) and a media drive that can access the medium. The external storage device may be a server apparatus connected via a network. The storage 204 stores programs for implementing the functions of the applications to be described later with reference to FIG. 2 and the control processes to be described later with reference to FIGS. 4 and 5, the image data such as a still image or a moving image obtained from the image capture apparatus 100 or the external storage device, and the like.

The operation unit 205 includes a pointing device such as a mouse or a touch panel that accepts a user operation and an input device such as a joystick or a keyboard, and outputs an operation instruction to the control unit 201.

The display unit 206 is an output device such as a display formed by an LCD or an organic EL display, and displays a Graphical User Interface (GUI) of each application, a menu screen, a captured image, various operation buttons, and the like.

The communication interface (I/F) 207 executes communication with the image capture apparatus 100 via a network such as the Internet or a Local Area Network (LAN) by a wired method or a wireless method. The information processing apparatus 200 according to the present embodiment obtains the moving image file in the format other than the RAW format or the moving image file in the RAW format from the image capture apparatus 100, the external storage device, or the like via the communication I/F 207, and performs development processing and image composition processing thereon.

The system bus 208 includes an address bus, a data bus, and a control bus that connect the components 201 to 207 of the information processing apparatus 200 to be able to exchange data.

Programs including an Operating System (OS) as basic software to be executed by the control unit 201 and applications that implement applicable functions in cooperation with the OS are recorded in the nonvolatile memory 202.

The functions of the development processing and the image composition processing of the information processing apparatus 200 according to the present embodiment are implemented by software components provided by the applications to be described later with reference to FIG. 2. Note that each application includes software configured to use the basic function of the OS installed in the information processing apparatus 200. Note also that the OS of the information processing apparatus 200 may include software configured to implement processing according to the present embodiment.

### Development Processing and Image Composition Processing

The functions of a development application and an image composition application according to the present embodiment will be described next with reference to FIG. 2.

FIG. 2 is a view illustrating functions of the development application and the image composition application according to the present embodiment.

The present embodiment will describe an example in a case where peripheral illumination and distortion aberration occur as the optical aberration of the image capture optical system of the image capture apparatus 100, and as optical aberration correction set in the image capture apparatus 100, peripheral illumination correction is set to OFF and distortion aberration correction is set to ON. In the present embodiment, if a moving image file in the RAW format is input to the information processing apparatus 200, a development application 250 performs development processing of the RAW moving image data by applying the distortion aberration correction set to ON in the image capture apparatus 100.

Note that development processing by the development application and image composition processing by the image composition application are independent of each other, and the development processing is not always based on the image composition processing. Therefore, even if first, second, and third correction data are added to a RAW moving image file, both of the first correction processing and the second correction processing are not always applied in the development processing regardless of the optical aberration correction set in the image capture apparatus 100. For example, in some cases, without assuming execution of the image composition processing in the development processing, the peripheral illumination correction is unnecessary and only the distortion aberration correction is applied, and CG composition is performed at an editing stage. In this case, since it takes labor to apply the first correction processing and the second correction processing again in the development processing, it is desirable to be able to apply the peripheral illumination correction in the image composition processing as in the present embodiment. The image composition processing is often executed by an organization or team different from that for the development processing. In this case, it is assumed a case where the image composition processing is performed using a developed moving image to which only distortion correction has been applied.

In FIG. 2, in S251, the development application 250 receives, from the image capture apparatus 100, a RAW moving image file shot in a state in which the distortion aberration correction is set to ON. In S252, development processing is performed by applying the distortion aberration correction using the second correction data added to the input RAW moving image file. In S253, the developed moving image to which the distortion aberration correction has been applied is output.

In S261, an image composition application 260 receives a moving image file developed by the development application 250 or receives, from the image capture apparatus 100, a moving image file shot in a format other than the RAW format in a state in which the distortion aberration correction is set to ON. CG is input in S263, and image composition processing of the moving image and CG is executed in S264. At this time, since CG includes no optical aberration, it is necessary to remove the optical aberration from the moving image before image composition. Since the distortion aberration correction has already been applied to the input moving image, peripheral illumination correction is applied using the third correction data in S262, and a moving image to which the distortion aberration correction and the peripheral illumination correction have been applied and that can be composited is generated in S264. In S265, a moving image is generated by compositing, with CG, the moving image to which the distortion aberration correction and the peripheral illumination correction have been applied.

When the moving image obtained by performing image composition in S265 is returned to a moving image to which no peripheral illumination correction has been applied, inverse transformation of the peripheral illumination correction is applied in S266, thereby making it possible to generate, in S267, a moving image by compositing, with CG, the moving image to which only the distortion aberration correction has been applied.

To the contrary, conventionally, the image composition application generally applies the distortion aberration correction to the moving image after applying the peripheral illumination correction. In this case, since correction data used for the peripheral illumination correction is data effective only for the moving image obtained before the distortion aberration correction is performed and cannot thus be applied to the image obtained after the distortion aberration correction has been applied, it is impossible to apply the peripheral illumination correction in S261 of FIG. 2.

In the present embodiment, since the moving image input to the information processing apparatus 200 is provided with the correction data that can be used to apply the peripheral illumination correction to the moving image to which the distortion aberration correction has been applied, it is possible to apply, in S261, the peripheral illumination correction to the moving image to which the distortion aberration correction has been applied.

### Moving Image Shooting Processing

Next, moving image shooting processing by the image capture apparatus 100 according to the present embodiment will be described with reference to FIGS. 3A and 3B.

FIGS. 3A and 3B exemplify flowcharts of moving image shooting processing by the image capture apparatus according to the present embodiment.

The processing shown in FIGS. 3A and 3B is implemented when the control unit 101 controls the respective components of the image capture apparatus 100 by loading a program stored in the nonvolatile memory 104 into the volatile memory 105 and executing the program.

The present embodiment will describe an example in a case where peripheral illumination correction (first correction processing) and distortion aberration correction (second correction processing) can be applied as optical aberration correction of the image capture optical system at the time of moving image shooting of the image capture apparatus 100.

In step S300, the control unit 101 sets a frame count N (N is an integer) to 1.

In step S301, the control unit 101 determines whether the peripheral illumination correction is set to ON. When it is determined that the peripheral illumination correction is set to ON, the control unit 101 advances the process to step S305. When it is determined that the peripheral illumination correction is not set to ON, the control unit 101 advances the process to step S310.

In step S305, the control unit 101 determines whether the format of a shot moving image is the RAW format. When it is determined that the format is the RAW format, the control unit 101 advances the process to step S310. When it is determined that the format is not the RAW format, the control unit 101 advances the process to step S315.

In step S310, the control unit 101 records, as metadata of a shot moving image, correction data to be used to apply the peripheral illumination correction to an image of an Nth frame. The recorded metadata associated with the peripheral illumination correction is correction data (first correction data) used to apply the peripheral illumination correction to a moving image obtained before the distortion aberration correction is applied. In a case where the peripheral illumination correction is set to OFF, the first correction data is recorded regardless of whether the format of the shot moving image is the RAW format or not. In a case where the peripheral illumination correction is set to ON, the first correction data is recorded when the format of the shot moving image is the RAW format, and is not recorded when the format is other than the RAW format.

In step S315, the control unit 101 applies the peripheral illumination correction to the image of the Nth frame.

In step S320, the control unit 101 determines whether the distortion aberration correction is set to ON. When it is determined that the distortion aberration correction is set to ON, the control unit 101 advances the process to step S325. When it is determined that the distortion aberration correction is not set to ON, the control unit 101 advances the process to step S340.

In step S325, the control unit 101 determines whether the format of the shot moving image is the RAW format. When it is determined that the format is the RAW format, the control unit 101 advances the process to step S330. When it is determined that the format is not the RAW format, the control unit 101 advances the process to step S335.

In step S340, the control unit 101 determines whether the format of the shot moving image is the RAW format. When it is determined that the format is the RAW format, the control unit 101 advances the process to step S330. When it is determined that the format is not the RAW format, the control unit 101 advances the process to step S345.

In step S345, the control unit 101 records, as metadata of the shot moving image, correction data to be used to apply the distortion aberration correction to the image of the Nth frame. The recorded metadata associated with the distortion aberration correction is correction data (second correction data) used to apply the distortion aberration correction to the moving images obtained before and after the peripheral illumination correction is applied. In a case where the distortion aberration correction is set to OFF, the second correction data is recorded regardless of whether the format of the shot moving image is the RAW format or not.

In step S330, the control unit 101 records, as metadata of the shot moving image, correction data to be used to apply the distortion aberration correction to the image of the Nth frame. The recorded metadata associated with the distortion aberration correction is correction data (second correction data) used to apply the distortion aberration correction to the moving images obtained before and after the peripheral illumination correction is applied. In a case where the distortion aberration correction is set to ON, the second correction data is recorded when the format of the shot moving image is the RAW format, and is not recorded when the format is other than the RAW format.

In step S335, the control unit 101 applies the distortion aberration correction to the image of the Nth frame.

In step S350, the control unit 101 records, as metadata of the shot moving image, correction data to be used to apply the peripheral illumination correction to the image of the Nth frame. The recorded metadata associated with the peripheral illumination correction is correction data (third correction data) used to apply the peripheral illumination correction to the moving image obtained after the distortion aberration correction has been applied. In a case where the format of the shot moving image is the RAW format, the third correction data is recorded regardless of whether the distortion aberration correction is set to ON or OFF. In a case where the distortion aberration correction is set to ON and the format of the shot moving image is other than the RAW format, the third correction data is recorded in the moving image to which the distortion aberration correction has been applied.

In step S355, the control unit 101 records the image of the Nth frame in the moving image file.

In step S360, the control unit 101 determines whether to end shooting. When it is determined to end shooting, the control unit 101 ends the processing. When it is determined not to end shooting, the control unit 101 advances the process to step S365, and adds 1 to the frame count N, thereby returning the process to step S301.

The moving image file shot by the processing shown in FIGS. 3A and 3B and the metadata recorded in the moving image file are transmitted to the information processing apparatus 200.

With the processing shown in FIGS. 3A and 3B, when shooting a RAW moving image, the image capture apparatus 100 according to the present embodiment records, as metadata, in the RAW moving image, the first correction data, the second correction data, and the third correction data to be used for the optical aberration correction without applying the development processing of the RAW moving image and the optical aberration correction. Thus, it makes it possible to apply the optical aberration correction in the development processing and the image composition processing of the RAW moving image by the information processing apparatus 200.

In addition, based on the format of the shot moving image and the optical aberration correction not applied to the moving image to be shot, the image capture apparatus 100 according to the present embodiment records the moving image to be shot and correction data to be used to apply, to the moving image, the optical aberration correction not applied to the moving image to be shot.

More specifically, when shooting a moving image in a format other than the RAW format, the image capture apparatus 100 according to the present embodiment records, as a moving image file, moving image data developed by applying the optical aberration correction set to ON in the image capture apparatus 100. In addition, the image capture apparatus 100 according to the present embodiment records, as metadata, in the moving image file, correction data to be used for unapplied optical aberration correction, among the first correction data, the second correction data, and the third correction data.

More specifically, when shooting a moving image in a format other than the RAW format, if neither the first correction processing nor the second correction processing has been applied, at least the first correction data and the second correction data are recorded as metadata. If the first correction processing has been applied, at least the second correction data is recorded as metadata, and if the second correction processing has been applied, at least the third correction data is recorded as metadata. If the first correction processing and the second correction processing have been applied, neither the first correction data, the second correction data, nor the third correction data is recorded. In this way, optical aberration corrections that has not been applied by the image capture apparatus 100 can be applied in image composition processing by the information processing apparatus 200.

### Development Processing

Next, development processing by the information processing apparatus 200 according to the present embodiment will be described with reference to FIG. 4.

FIG. 4 exemplifies a flowchart of development processing by the information processing apparatus 200 according to the present embodiment.

The processing shown in FIG. 4 is implemented when the control unit 201 controls the respective components of the information processing apparatus 200 by executing the development application.

In the processing shown in FIG. 4, the information processing apparatus 200 obtains the moving image file shot by the processing shown in FIGS. 3A and 3B and the metadata recorded in the moving image file from the image capture apparatus 100 or an external storage device.

The present embodiment will describe an example in a case where the development application of the information processing apparatus 200 can apply peripheral illumination correction (first correction processing) and distortion aberration correction (second correction processing) in development processing of an input moving image.

In step S400, the control unit 201 determines whether the moving image file is loaded. When it is determined that the moving image file is loaded, the control unit 201 advances the process to step S405. When it is determined that the moving image file is not loaded, the control unit 201 returns the process to step S400.

In step S405, the control unit 201 determines whether the moving image file loaded in step S400 is in the RAW format. When it is determined that the moving image file is in the RAW format, the control unit 201 advances the process to step S410. When it is determined that the moving image file is not in the RAW format, the control unit 201 ends the processing.

In step S410, the control unit 201 sets the frame count N (N is an integer) to 1.

In step S415, the control unit 201 obtains the image of the Nth frame from the moving image file loaded in step S400.

In step S420, the control unit 201 determines whether the moving image file loaded in step S400 has been shot in a state in which the peripheral illumination correction is set to ON. When it is determined that the moving image file has been shot in the state in which the peripheral illumination correction is set to ON, the control unit 201 advances the process to step S425. When it is determined that the moving image file has not been shot in the state in which the peripheral illumination correction is set to ON, the control unit 201 advances the process to step S435.

In step S425, the control unit 201 obtains, from the metadata of the moving image file loaded in step S400, correction data (first correction data) used to apply the peripheral illumination correction to the image of the Nth frame. The obtained correction data associated with the peripheral illumination correction is correction data (first correction data) used to apply the peripheral illumination correction to the image before the distortion aberration correction is applied.

In step S430, the control unit 201 applies the peripheral illumination correction to the image of the Nth frame using the correction data obtained in step S425.

In step S435, the control unit 201 determines whether the moving image file loaded in step S400 has been shot in a state in which the distortion aberration correction is set to ON. When it is determined that the moving image file has been shot in the state in which the distortion aberration correction is set to ON, the control unit 201 advances the process to step S440. When it is determined that the moving image file has not been shot in the state in which the distortion aberration correction is set to ON, the control unit 201 advances the process to step S450.

In step S440, the control unit 201 obtains, from the metadata of the moving image file loaded in step S400, correction data (second correction data) used to apply the distortion aberration correction to the image of the Nth frame.

In step S445, the control unit 201 applies the distortion aberration correction to the image of the Nth frame using the correction data obtained in step S440.

In step S450, the control unit 201 applies the remaining development processing to the image of the Nth frame.

In step S455, the control unit 201 determines whether the Nth frame being processed is the final frame. When it is determined that the Nth frame is the final frame, the control unit 201 ends the processing. When it is determined that the Nth frame is not the final frame, the control unit 201 advances the process to step S460, and adds 1 to the frame count N, thereby returning the process to step S415.

The moving image data developed by the processing shown in FIG. 4 is usable for image composition processing of the image composition application.

### Image Composition Processing

Next, image composition processing by the information processing apparatus 200 according to the present embodiment will be described with reference to FIGS. 5A and 5B.

FIGS. 5A and 5B exemplify flowcharts of image composition processing by the information processing apparatus 200 according to the present embodiment.

The processing shown in FIGS. 5A and 5B is implemented when the control unit 201 controls the respective components of the information processing apparatus 200 by executing the image composition application.

The present embodiment will describe an example in a case where the image composition application of the information processing apparatus 200 can apply peripheral illumination correction (first correction processing) and distortion aberration correction (second correction processing) to a developed moving image.

In step S500, the control unit 201 determines whether a moving image file is loaded. When it is determined that the moving image file is loaded, the control unit 201 advances the process to step S505. When it is determined that the moving image file is not loaded, the control unit 201 returns the process to step S500. The loaded moving image file is the moving image file shot in the format other than the RAW format by the processing shown in FIGS. 3A and 3B or the moving image file developed by the processing shown in FIG. 4.

In step S505, the control unit 201 sets the frame count N to 1.

In step S510, the control unit 201 obtains the image of the Nth frame from the moving image file loaded in step S500.

In step S515, the control unit 201 determines whether the image of the Nth frame obtained in step S510 is a target frame of the image composition processing. When it is determined that the image is the target frame of the image composition processing, the control unit 201 advances the process to step S525. When it is determined that the image is not the target frame of the image composition processing, the control unit 201 advances the process to step S520, and adds 1 to the frame count N, thereby returning the process to step S510.

In step S525, the control unit 201 determines whether the peripheral illumination correction has been applied to the image of the Nth frame obtained in step S510. When it is determined that the peripheral illumination correction has been applied to the image, the control unit 201 advances the process to step S530. When it is determined that the peripheral illumination correction has not been applied to the image, the control unit 201 advances the process to step S545.

In step S530, the control unit 201 determines whether the distortion aberration correction has been applied to the image of the Nth frame obtained in step S510. When it is determined that the distortion aberration correction has been applied to the image, the control unit 201 advances the process to step S580. When it is determined that the distortion aberration correction has not been applied to the image, the control unit 201 advances the process to step S535.

In step S535, the control unit 201 obtains, from the metadata of the moving image file loaded in step S500, correction data (second correction data) used to apply the distortion aberration correction to the image of the Nth frame.

In step S540, the control unit 201 applies the distortion aberration correction to the image of the Nth frame using the correction data obtained in step S535.

In step S545, the control unit 201 determines whether the distortion aberration correction has been applied to the image of the Nth frame obtained in step S510. When it is determined that the distortion aberration correction has been applied to the image, the control unit 201 advances the process to step S550. When it is determined that the distortion aberration correction has not been applied to the image, the control unit 201 advances the process to step S560.

In step S550, the control unit 201 obtains, from the metadata of the moving image file loaded in step S500, correction data (third correction data) used to apply the peripheral illumination correction to the image of the Nth frame to which the distortion aberration correction has been applied.

In step S555, the control unit 201 applies the peripheral illumination correction to the image of the Nth frame using the correction data obtained in step S550.

In step S560, the control unit 201 obtains, from the metadata of the moving image file loaded in step S500, correction data (first correction data) used to apply the peripheral illumination correction to the image of the Nth frame obtained before the distortion aberration correction is applied.

In step S565, the control unit 201 applies the peripheral illumination correction to the image of the Nth frame using the correction data obtained in step S560.

In step S570, the control unit 201 obtains, from the metadata of the moving image file loaded in step S500, correction data (second correction data) used to apply the distortion aberration correction to the image of the Nth frame.

In step S575, the control unit 201 applies the distortion aberration correction to the image of the Nth frame using the correction data obtained in step S570.

In step S580, the control unit 201 generates a composite image by compositing the image of the nth frame with CG.

In step S585, the control unit 201 determines whether the Nth frame being processed is the final frame. When it is determined that the Nth frame is the final frame, the control unit 201 ends the processing. When it is determined that the Nth frame is not the final frame, the control unit 201 advances the process to step S520, and adds 1 to the frame count N, thereby returning the process to step S510.

With the processes shown in FIGS. 4 and 5, by using correction data used to apply unapplied correction processing, the information processing apparatus 200 according to the present embodiment applies, to a composition target moving image, the unapplied correction processing that has not been applied to the moving image to be composited with CG in the image composition processing.

More specifically, if an input moving image file is in the RAW format, the information processing apparatus 200 according to the present embodiment executes the development processing and the image composition processing. Alternatively, if the input moving image file is in a format other than the RAW format, the information processing apparatus 200 according to the present embodiment executes the image composition processing without executing the development processing.

Furthermore, if the input moving image file is in the RAW format, the information processing apparatus 200 according to the present embodiment performs the development processing of the RAW moving image data, and applies the optical aberration correction using correction data recorded as the metadata in the RAW moving image data, thereby compositing the thus obtained data with CG.

When the input moving image file is in the format other than the RAW format, in a case where the second correction processing has been applied to the moving image data and the first correction processing has not been applied thereto, the information processing apparatus 200 according to the present embodiment applies the first correction processing using the third correction data in the image composition processing. In a case where neither the first correction processing nor the second correction processing has been applied to the moving image data, the first correction processing is applied using the first correction data and the second correction processing is executed using the second correction data. In this way, in the image composition processing, the information processing apparatus 200 according to the present embodiment can execute the image composition processing with CG after applying the first correction processing and the second correction processing to the moving image data. In the image composition processing, even if the first correction processing has not been applied to the moving image data and the second correction processing has been applied thereto, the information processing apparatus 200 according to the present embodiment can apply the first correction processing using the third correction data, and execute the image composition processing with CG after applying the first correction processing and the second correction processing.

According to the present embodiment, based on the format of the shot moving image and the optical aberration correction that has not been applied to the shot moving image, the image capture apparatus 100 records the shot moving image and the correction data to be used to apply, to the moving image, the optical aberration correction that has not been applied to the shot moving image. This allows the information processing apparatus 200 to apply necessary optical aberration correction while suppressing degradation of image quality at the time of image composition.

### Other Embodiment

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-214572, filed Dec. 9, 2024 which is hereby incorporated by reference herein in its entirety.

What is claimed is:

1. An image capture apparatus comprising:
an imaging unit that captures an object image through an optical system; and
a recording unit that records an image captured by the imaging unit and records third correction data to be used to apply first correction processing including at least one of peripheral illumination correction and lateral chromatic aberration correction to an image to which second correction processing including at least one of distortion correction and image magnification correction is applied.

2. The apparatus according to claim 1, wherein
the third correction data is correction data to be used to apply the first correction processing to the image to which the second correction processing has been applied in an information processing apparatus communicatively connected to the image capture apparatus.

3. The apparatus according to claim 1, wherein
the image is a moving image, and
the apparatus further comprises a setting unit that sets whether to apply each of the first correction processing and the second correction processing to a frame of the moving image.

4. The apparatus according to claim 3, wherein
in a case where the setting unit sets not to apply the first correction processing to the frame of the moving image and to apply the second correction processing to the frame of the moving image, the recording unit records the third correction data.

5. The apparatus according to claim 4, wherein
the recording unit records first correction data to be used to apply the first correction processing to an image obtained before the second correction processing is applied.

6. The apparatus according to claim 5, wherein
in a case where the image recorded by the recording unit is in a RAW format, the recording unit further records second correction data to be used to apply the second correction processing to the image to which the first correction processing has been applied, and
in a case where the image recorded by the recording unit is not in the RAW format, the recording unit does not record the second correction data.

7. A method of controlling an image capture apparatus comprising:
capturing an object image through an optical system; and
recording an image obtained in the capturing and recording third correction data to be used to apply first correction processing including at least one of peripheral illumination correction and lateral chromatic aberration correction to an image to which second correction processing including at least one of distortion correction and image magnification correction is applied.

8. A system in which an image capture apparatus and an information processing apparatus are communicatively connected,
wherein the image capture apparatus comprises
an imaging unit that captures an object image through an optical system, and
a recording unit that records an image captured by the imaging unit and records third correction data to be used to apply first correction processing including at least one of peripheral illumination correction and lateral chromatic aberration correction to an image to which second correction processing including at least one of distortion correction and image magnification correction is applied, and
wherein the information processing apparatus comprises
an obtaining unit that obtains the third correction data from the image capture apparatus, and
a processing unit that applies, to the image to which the second correction processing has been applied, the first correction processing using the third correction data obtained by the obtaining unit.
